(19) United States
(12) Patent Application Publication
(10) Pub. No.: US 2024/0218804 A1
(43) Pub. Date: Jul. 4, 2024

(54) A GAS TURBINE AND GENERATOR ARRANGEMENT

(71) Applicant: ROLLS-ROYCE PLC, London (GB)

(72) Inventor: Roy J. HARRON, Bristol (GB)

(73) Assignee: ROLLS-ROYCE PLC, London (GB)

(21) Appl. No.: 18/534,024

(22) Filed: Dec. 8, 2023

(30) Foreign Application Priority Data
Jan. 4, 2023 (GB) 2300066.4

(51) Int. Cl. F01D 15/10; B63H 21/16; F01D 15/12

(52) U.S. Cl. CPC F01D 15/10; B63H 21/16; F01D 15/12; F05D 2220/76; F05D 2260/4031

(57) ABSTRACT

A gas turbine and generator arrangement comprising a gas turbine engine (201) and a generator (207), the gas turbine engine comprising a turbine output shaft (319), characterised in that the gas turbine engine and the generator are horizontally or vertically spaced apart from each other in a lateral direction and a gearbox (325) translates the rotation of the turbine output shaft to drive a gearbox output shaft (329) which in turn drives the generator.

### FIELD OF THE DISCLOSURE

The present disclosure concerns an arrangement for installing a gas turbine engine in conjunction with a generator. It is particularly, though not exclusively, relevant for such installations in marine applications.

### BACKGROUND

It is known to power ships, for example warships, using one or more gas turbine engines. The gas turbine engine or engines may provide propulsion to the ship directly, via one or more gearboxes.

Alternatively, the propulsion may be electrical: the gas turbine engine or engines drive one or more electrical generators and the generated electrical power drives electric motors connected to the propellors.

Such arrangements are known and need not be described in detail here. In short, a rotating output shaft takes power from a turbine of the gas turbine engine and thereby drives an electrical generator arranged in line with the gas turbine engine. Such an arrangement, also known as a propulsion package, is shown in FIG. 2.

A disadvantage of known arrangements is that the footprint of the propulsion package is relatively long, and this can make it difficult to install it in a ship's machinery space (e.g., a machinery room) where space is limited. It would be desirable to provide a propulsion package with a more compact footprint, which could more readily be accommodated in confined spaces. Ships are commonly designed with standard sized compartments for machinery, and a more compact arrangement of propulsion package will fit into a wider variety of ships without modification of the propulsion package or of the ship; the latter of which is especially undesirable. Furthermore, the less room that is taken up in a ship's machinery space by the propulsion package, the more room will be available for other equipment and ancillary systems (e.g., fire protection systems, fuel systems, control systems).

It would therefore be desirable to devise an alternative arrangement of gas turbine engine and generator that mitigates or overcomes these disadvantages.

### SUMMARY

According to a first aspect, a gas turbine and generator arrangement comprises a gas turbine engine and a generator, the gas turbine engine comprising a turbine output shaft, characterised in that the gas turbine engine and the generator are horizontally or vertically spaced apart from each other in a lateral direction and a gearbox translates the rotation of the turbine output shaft to drive a gearbox output shaft which in turn drives the generator.

Such an arrangement accommodates the gas turbine and generator arrangement in a more compact manner than in known arrangements, typically requiring some four metres less space in the axial direction.

The gas turbine engine and the turbine output shaft may be coaxial.

The gearbox output shaft and the generator may be coaxial.

A rotational axis of the turbine output shaft may be parallel to a rotational axis of the gearbox output shaft.

The direction of rotation of the gearbox output shaft 329 may be opposite to the direction of rotation of the turbine output shaft 319, so that the gas turbine engine and the generator are contra-rotating.

The torque reactions of the gas turbine engine and the generator can thereby be made to partially or wholly cancel out. This reduces the tendency of the baseplate to try and tip to one side while the system is in operation.

The rotational axis of the turbine output shaft may be vertically higher or lower than a rotational axis of the gearbox output shaft.

This permits the use of generators with differing centre-line heights, with the difference in centreline height being accommodated within the gearbox with a variable output pinion.

The gearbox may be configured so that the rotational speed of the gearbox output shaft is higher or lower than the rotational speed of the turbine output shaft.

This permits the use of a generator 207 with a higher number of poles—for example, a four-, eight- or sixteen-pole generator rather than a two-pole generator

The gas turbine engine and the generator may be mounted on a baseplate.

The gas turbine engine and the generator may be vertically spaced apart from each other and the baseplate may be a ‘bunk bed’-style baseplate in which the baseplate is in two separate parts spaced apart vertically and connected by vertical posts or support columns.

This may lower the centre of gravity of the propulsion package.

The gearbox may comprise at least one bevel gear and at least one shaft.

The arrangement may be a propulsion package for a ship.

According to a second aspect, a ship includes an arrangement according to any one of the preceding 15 paragraphs.

The skilled person will appreciate that except where mutually exclusive, a feature described in relation to any one of the above aspects may be applied mutatis mutandis to any other aspect. Furthermore, except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a perspective view of a conventional gas turbine and generator arrangement;

FIG. 3 is a perspective view of a gas turbine and generator arrangement in accordance with the first aspect; and

FIG. 4 is a perspective view of part of the arrangement of FIG. 3.

### DETAILED DESCRIPTION

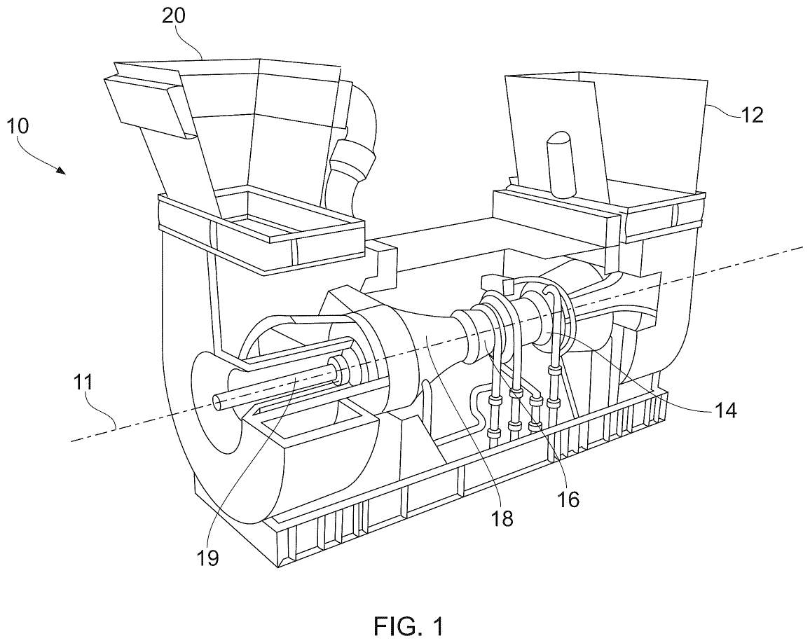

With reference to FIG. 1, a marine gas turbine engine is generally indicated at 10, having a principal and rotational axis 11. The engine 10 comprises, in axial flow series, an air intake 12, a compressor 14, combustion equipment 16, a turbine 18, an output shaft 19 and an exhaust duct 20.

The gas turbine engine 10 works in the conventional manner so that air entering the intake 12 is compressed by the compressor 14. The compressed air is directed into the combustion equipment 16 where it is mixed with fuel and the mixture combusted. The resultant hot combustion products then expand through, and thereby drive, the turbine 18 before being exhausted through the duct 20. Some of the power from the turbine 18 drives the compressor 14 via a suitable interconnecting shaft (not shown). The remainder of the power from the turbine 18 drives an output shaft 19. The turbine 18 may comprise a first turbine that drives the compressor 14 and a second turbine (sometimes known as a free power turbine) that drives the output shaft 19.

When the engine 10 is installed in a ship, air is provided to the air intake 12 and exhausted from the exhaust duct 20 by respective further ducts (not shown) which terminate at outer surfaces of the ship.

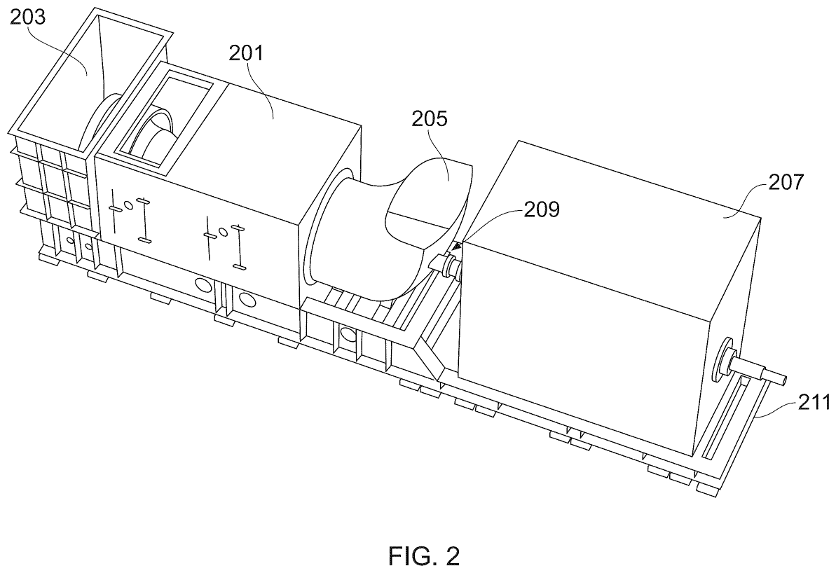

FIG. 2 shows a gas turbine and generator installation of known type. A gas turbine engine 201 includes an air intake 203 and an exhaust 205. A free power turbine (not shown) drives a generator 207 via an output shaft 209. Each of the gas turbine engine 201, the output shaft 209, and the generator 207 has a respective rotational axis (not shown). The gas turbine engine 201, the output shaft 209, and the generator 207 are mutually coaxial. The gas turbine engine 201 and the generator 207 are mounted on a baseplate 211, which permits the installation to be installed or removed as a single unit.

As noted above, a disadvantage of such an installation is that its footprint is relatively long, and this can make it difficult to install it in a standard sized compartment or other limited space in a ship. Previous attempts to overcome this problem have focused on reducing the length of the individual components of the installation, but there is typically very limited scope to do this.

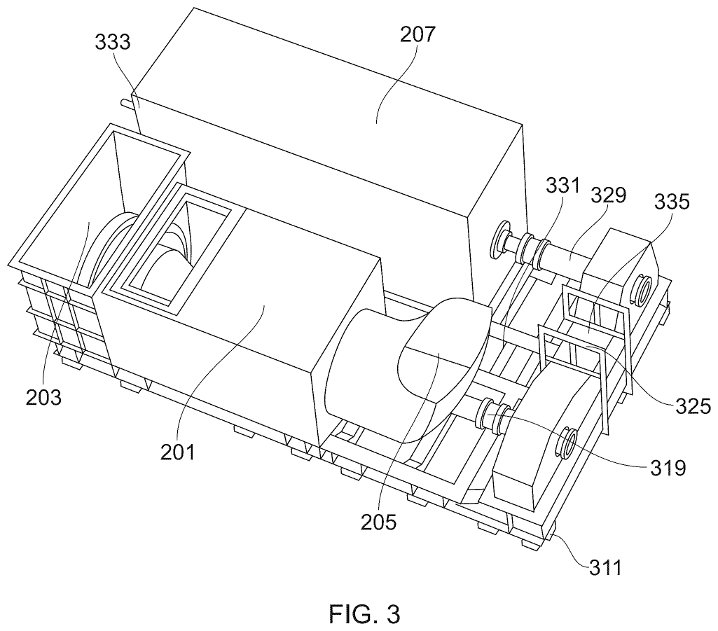

FIG. 3 shows a gas turbine and generator installation according to a first aspect. Certain components are identical to those shown in FIG. 2 and are identified by the same reference numbers.

A gas turbine engine 201 includes an air intake 203 and an exhaust 205. The gas turbine engine 201 is mounted on a baseplate 311 together with a generator 207.

The baseplate 311 includes a walkway 331, which provides convenient access both to the gas turbine engine and to the generator, for example for inspection or servicing. Access to the walkway 331 is possible both at the front 333 and at the rear 335 (via a ladder) of the installation.

The gas turbine engine 201 and the generator 207 are horizontally spaced apart from each other in a lateral direction, so that their respective rotational axes are parallel. The term “lateral direction” means a direction perpendicular to the respective rotational axes.

A free power turbine (not shown) in the gas turbine engine 201 drives a turbine output shaft 319 whose rotational axis is coaxial with the rotational axis of the gas turbine engine 201. The turbine output shaft 319 drives an input of a gearbox 325. The gearbox 325 is of known configuration and comprises a plurality of idler gears in meshing engagement with one another. An output of the gearbox 325 drives a gearbox output shaft 329 horizontally spaced apart from the turbine output shaft 319 in a lateral direction. A rotational axis of the gearbox output shaft 329 is coaxial with the rotational axis of the generator 207. The gearbox output shaft 329 drives the generator 207.

The gearbox 325 therefore translates the rotation of the turbine output shaft 319 to drive the gearbox output shaft 329 and thereby the generator 207. This permits the generator 207 and gas turbine engine 201 to be arranged alongside and parallel to each other, in contrast to the coaxial arrangement of FIG. 2. In effect the gearbox 325 reverses the direction of drive.

In a further aspect (not shown in FIG. 3), by suitable selection of the number of idler gears in the gearbox 325 the direction of rotation of the gearbox output shaft 329 can be arranged to be opposite to the direction of rotation of the turbine output shaft 319, so that the gas turbine engine and the generator are contra-rotating. The torque reactions of the gas turbine engine and the generator can thereby be made to partially or wholly cancel out. This reduces the tendency of the baseplate 311 to try and tip to one side while the system is in operation.

The arrangement shown in FIG. 3 therefore accommodates the gas turbine and generator arrangement in a more compact manner than in known arrangements, typically requiring some four metres less space in the axial direction.

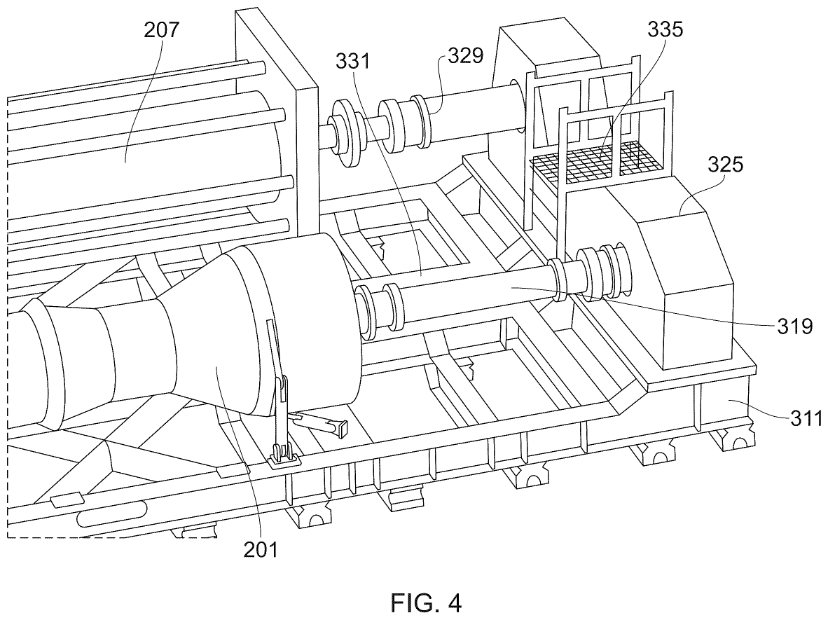

FIG. 4 is a perspective view of part of the arrangement of FIG. 3. Certain components are identical to those shown in FIG. 3 and are identified by the same reference numbers. The rear access 335 to the walkway 331 may be clearly seen, including a ladder over the gearbox 325.

In the aspect shown in FIG. 4, the gearbox output shaft 329 is vertically higher than the turbine output shaft 319. It will be appreciated that this is easily achieved by suitable configuration of the gearbox 325. Advantageously, this allows the gearbox output shaft 329 to be raised in height to account for the difference in centreline height of the gas turbine 201 and the generator 207. Typically, a generator has a higher centreline height than a gas turbine; but it will be appreciated that the gearbox may also be configured so that the gearbox output shaft 329 is lower than the turbine output shaft 319. This flexibility permits different generators, with differing centre-line heights (e.g. from different suppliers), to be installed on the same baseplate 311, with the difference in centreline height being accommodated within the gearbox with a variable output pinion (i.e. a pinion which can be reduced/increased in size, or else raised/lowered in height).

The gearbox may be configured so that the rotational speed of the gearbox output shaft 329 is higher or lower than the rotational speed of the turbine output shaft. The means for achieving this (by changing the respective numbers of teeth on the input and output gears (not shown) within the gearbox 325) is well-known and need not be described here. Advantageously, a higher rotational speed for the gearbox output shaft 329 permits the use of a generator 207 with a higher number of poles—for example, a four-, eight- or sixteen-pole generator rather than a two-pole generator. This permits a wider range of generators 207 to be used, potentially including smaller, cheaper, or lighter generators.

In a further aspect, not illustrated in the drawings, the generator (207 in FIG. 3) is mounted vertically above or below the gas turbine engine (201 in FIG. 3). This may conveniently be achieved using a ‘bunk bed’-style baseplate in which the baseplate is in two separate parts (one for the generator (207 in FIG. 3) and one for the gas turbine engine (201 in FIG. 3)) spaced apart vertically and connected by vertical posts or support columns. The gearbox (325 in FIG. 3) is suitably configured and orientated to transmit drive from the gas turbine to the generator via the turbine output shaft (319 in FIG. 3) and the gearbox output shaft (329 in FIG. 3). The gearbox may be configured to transmit drive via suitable bevel gears and a vertical rotating shaft rather than by a train of idler gears.

In a particular embodiment of this aspect, the generator is mounted on the lower part of the baseplate and the gas turbine engine is mounted on the upper part of the baseplate. Because generators are generally heavier than gas turbine engines, this has the advantage of lowering the centre of gravity of the propulsion package. A further advantage is that the further ducts that connect to the air intake (12 in FIG. 1) and the exhaust duct (20 in FIG. 1)—which are usually routed through the ceiling or roof of the ship's machinery room—may be made shorter and lighter.

It will be understood that the invention is not limited to the above-described embodiments, and various modifications and improvements can be made without departing from the concepts described herein. Except where mutually exclusive, any of the features may be employed separately or in combination with any other features and the disclosure extends to and includes all combinations and sub-combinations of one or more features described herein.

1. A gas turbine and generator arrangement comprising a gas turbine engine and a generator, the gas turbine engine comprising a turbine output shaft, characterised in that the gas turbine engine and the generator are horizontally or vertically spaced apart from each other in a lateral direction and a gearbox translates the rotation of the turbine output shaft to drive a gearbox output shaft which in turn drives the generator.

2. The arrangement of claim 1, in which the gas turbine engine and the turbine output shaft are coaxial.

3. The arrangement of claim 1, in which the gearbox output shaft and the generator are coaxial.

4. The arrangement of claim 1, in which a rotational axis of the turbine output shaft is parallel to a rotational axis of the gearbox output shaft.

5. The arrangement of claim 1, in which the direction of rotation of the gearbox output shaft is arranged to be opposite to the direction of rotation of the turbine output shaft, so that the gas turbine engine and the generator are contra-rotating.

6. The arrangement of claim 1, in which the rotational axis of the turbine output shaft is vertically higher or lower than a rotational axis of the gearbox output shaft.

7. The arrangement of claim 1, in which the gearbox is configured so that the rotational speed of the gearbox output shaft is higher or lower than the rotational speed of the turbine output shaft.

8. The arrangement of claim 1, in which the gas turbine engine and the generator are mounted on a baseplate.

9. The arrangement of claim 8, in which the gas turbine engine and the generator are vertically spaced apart from each other and the baseplate is a ‘bunk bed’-style baseplate in which the baseplate is in two separate parts spaced apart vertically and connected by vertical posts or support columns.

10. The arrangement of claim 9, in which the gearbox comprises at least one bevel gear and at least one shaft.

11. The arrangement of claim 1, which is a propulsion package for a ship.

12. A ship including an arrangement according to claim 1.
